(19) United States
(12) Patent Application Publication
(10) Pub. No.: US 2024/0169120 A1
(43) Pub. Date: May 23, 2024

(54) MULTI-FABRIC DESIGN GENERATION

(71) Applicant: DELL PRODUCTS L.P., Round Rock, TX (US)

(72) Inventors: Vinay SAWAL, Fremont, CA (US); Mihai LAZAR, Ottawa (CA); Jonathan STREETE, South San Francisco, CA (US); Joe Shahram GHALAM, Greenbrae, CA (US); Joseph LaSalle WHITE, San Jose, CA (US)

(73) Assignee: DELL PRODUCTS L.P., Round Rock, TX (US)

(21) Appl. No.: 18/429,273

(22) Filed: Jan. 31, 2024

Related U.S. Application Data
(63) Continuation-in-part of application No. 18/348,118, filed on Jul. 6, 2023.
Application No. 18/348,118 is a continuation-in-part of application No. 16/920,345, filed on Jul. 2, 2020, now Pat. No. 11,948,077.

(51) Int. Cl. G06F 30/20; G06N 3/0475

(52) U.S. Cl. CPC G06F 30/20; G06N 3/0475

(57) ABSTRACT

Presented herein are embodiments for automatically generating a multi-fabric design. In one or more embodiments, a multi-fabric design generator system comprises a plurality of generative machine learning models that, given a graph specification for a desired multi-fabric network, generates a set of preliminary graphs. The preliminary graphs may be input into an ensemble model that comprises a reinforcement learning module, which may be trained to select the best components from the various models to create a tailored design according to specific design criteria and customer requirements or constraints. Thus, given a set of desired requirements (e.g., latency, resistance to congestion, cost, scale, bijection, etc.), the multi-fabric design generator system generates a multi-fabric design that fulfills that set of requirements; thereby providing the ability to generate customized designs for each customer based on their requirements (e.g., technical, business, and regulatory).

### CROSS-REFERENCE TO RELATED APPLICATIONS

This patent application is a continuation-in-part application of and claims priority benefit under 35 USC § 120 to co-pending and commonly-owned U.S. patent application Ser. No. 18/348,118, filed on 6 Jul. 2023, entitled “AUTOMATED ANALYSIS OF AN INFRASTRUCTURE DEPLOYMENT DESIGN,” and listing Vinay Sawal, Joseph L. White, and Sithiqu Shahul Hameed as inventors (Docket No. DC-133284.01 (20110-2672)), which is a continuation-in-part application of and claims priority benefit under 35 USC § 120 to commonly-owned U.S. patent application Ser. No. 16/920,345, filed on 2 Jul. 2020, entitled “NETWORK FABRIC ANALYSIS,” and listing Vinay Sawal as inventor (Docket No. DC-119323.01 (20110-2398))-each of the aforementioned patent documents is incorporated by reference herein in its entirety and for all purposes.

### BACKGROUND

### A. Technical Field

The present disclosure relates generally to information handling systems. More particularly, the present disclosure relates to multi-fabric design generation.

### B. Background

The subject matter discussed in the background section shall not be assumed to be prior art merely as a result of its mention in this background section. Similarly, a problem mentioned in the background section or associated with the subject matter of the background section should not be assumed to have been previously recognized in the prior art. The subject matter in the background section merely represents different approaches, which in and of themselves may also be inventions.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The dramatic increase in computer usage and the growth of the Internet has led to a significant increase in networking. Networks, comprising such information handling systems as switches and routers, have not only grown more prevalent, but they have also grown larger and more complex. Network fabric can comprise a large number of information handling system nodes that are interconnected in a vast and complex mesh of links. As businesses and personal lives increasingly rely on networked services, networks provide increasingly more critical operations. Thus, it is important that a network fabric be well designed and function reliably.

While the complexity of a single network fabric has grown to staggering levels, the problem becomes nearly unmanageable when considering multi-fabric networks. Multi-fabric networks involve the combination and connection of a plurality of network fabrics. The design of a multi-cloud deployment poses significant challenges due to its inherent complexity and the need to account for various critical factors. Some of these factors include, but are not limited to, the following.
First, there is the overall complexity. Managing resources across multiple cloud providers can be complex. Each cloud provider has its own set of services, application programming interfaces (APIs), and management tools.
Second, there are the ever-present issues of interoperability. For a multi-fabric network to be useful, it must operate without issues. However, ensuring seamless interoperability between different cloud providers is challenging. Compatibility issues may arise when integrating services from one provider with those from another.
Third, there are different cost structures between the different providers. Therefore, merely considering the interoperability without considering other factors, like operational costs, when designing and deploying a multi-fabric network can result in excess charges. For example, data transfer fees associated with moving data between different cloud providers can incur significant costs.
Fourth, coordinating security measures and ensuring consistent security policies across multiple cloud providers can be challenging. Differences in security features and practices may lead to vulnerabilities, which are unacceptable to clients.
Fifth, there are performance variabilities and feature variabilities that should be considered. Different providers have different strengths and weaknesses, and they can offer different features or even variants of features that may need to be considered. Differences in performance characteristics and network latency between cloud providers may impact the overall performance of applications and services.
Sixth, there may be regulatory requirements to be considered-especially if a cloud crosses multiple jurisdictions. For example, different states may have different data protection and privacy laws that may be applicable to portions or all of the multi-fabric network.
Seventh, each cloud provider has its own service level agreement (SLA). These SLA may differ in terms of uptime guarantees, support, and response times. Aligning these variations can be challenging.
Finally, given the vastness of all of these different factors and the ever-increasing technical complexity of devices within a network, finding experts that are knowledgeable in all these areas is challenging and costly.

These are just some of the factors that should preferably be considered when designing and deploying a multi-fabric network. All of these factors present a nearly insurmountable problem for effectively integrating applications and services that span multiple cloud environments. Any incompatibilities may result in an issue that could affect the overall system performance.

Accordingly, there is a need for a multi-fabric network connectivity generator that is capable of comprehensively considering all relevant factors to produce a multi-fabric design.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 depicts a multi-fabric network modeled as an undirected acyclic graph, according to embodiments of the present disclosure.

FIG. 2 depicts an example of a network topology represented as an undirected acyclic graph, according to embodiments of the present disclosure.

FIG. 3 depicts another example of a network topology represented as an undirected acyclic graph, according to embodiments of the present disclosure.

FIG. 4 depicts an example of a multi-fabric topology represented as an undirected acyclic graph, according to embodiments of the present disclosure.

FIG. 5 depicts an overview methodology for training a multi-fabric design system, according to embodiments of the present disclosure.

FIG. 6 graphically illustrates a connectivity dataset, according to embodiments of the present disclosure.

FIG. 7 graphically depicts a multi-fabric design system architecture during a training phase, according to embodiments of the present disclosure.

FIG. 8 depicts a methodology for training a set of generative models, according to embodiments of the present disclosure.

FIG. 9 depicts a methodology for training an ensemble module of a multi-fabric design generator, according to embodiments of the present disclosure.

FIG. 10 graphically depicts an implementation of reinforcement learning, according to embodiments of the present disclosure.

FIG. 11 graphically depicts a trained multi-fabric design system architecture during a deployment phase, according to embodiments of the present disclosure.

FIG. 12 depicts an overview methodology for using a trained multi-fabric design system, according to embodiments of the present disclosure.

FIG. 13 depicts a simplified block diagram of an information handling system, according to embodiments of the present disclosure.

FIG. 14 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

In one or more embodiments, a stop condition may include: (1) a set number of iterations have been performed; (2) an amount of processing time has been reached; (3) convergence (e.g., the difference between consecutive iterations is less than a first threshold value); (4) divergence (e.g., the performance deteriorates); and (5) an acceptable outcome has been reached.

It shall also be noted that although embodiments described herein may be within the context of multi-fabric design generation, aspects of the present disclosure are not so limited. Accordingly, the aspects of the present disclosure may be applied or adapted for use in other contexts.

### A. General Introduction

To avoid vendor lock-in, many users opt for multiple cloud providers and hybrid environments, including on-site and colocation deployments, resulting in a heterogeneous setup. However, as noted above, the design of a multi-cloud deployment poses significant challenges due to its inherent complexity and the need to account for various critical factors. These factors include integration complexity, data migration, technical compatibility, security, compliance, cost management, vendor selection, performance monitoring, troubleshooting, among other factors. Technical challenges include network and protocol interoperability between cloud and backbone providers, selecting the right vendors and setup for the component fabrics, and ensuring appropriate robustness, throughput, latency, and network reliability.

In addition to technical network design and cost optimization challenges, non-technical factors, such as regulatory (e.g., data sovereignty, privacy, etc.), should also be considered. In some cases, due to the high cost of electrical power, network connectivity should be designed to allow quick reconfiguration of traffic to locations where the cost of electrical power is lower (e.g., to account for time-of-day cost electricity savings).

The difficulty of designing multi-cloud deployments is further compounded by the desire to design robust (“always on”) and cost-effective network connectivity involving multiple cloud and backbone providers. Such networks are, in essence, a “fabric of fabrics” or a multi-fabric. Hence, there is a need for an automatic multi-fabric network connectivity generator capable of comprehensively considering all relevant factors to produce well-formulated designs.

To address the aforementioned complexities, presented herein are embodiments of an automatic multi-fabric design generator. Embodiments comprehensively consider all relevant factors by leveraging machine learning and data analysis to produce a well-formulated, even optimized, design. Embodiments intelligently identify suitable fabrics, which may be represented as nodes in the multi-fabric, assess fabric compatibility and capabilities, and optimize connectivity between network component fabrics-all while taking into account a broad range of factors, such as technical, business, and regulatory considerations. Note also that embodiments may be continuously updated with data from new existing deployments (e.g., achievement of SLA in existing deployments).

### B. Training Embodiments

### 1. Graph Representation Embodiments

To facilitate using machine learning models, embodiments may represent a network fabric as an undirected acyclic graph, which may be a weighted undirected acyclic graph. In one or more embodiments, an undirected acyclic graph of a multi-fabric network may include (but is not limited to) the following properties:
Each fabric may be considered a separate subgraph, and the interconnections (e.g., links) between fabrics may be represented as edges (which may also be referred to links of a graph or subgraph) connecting nodes from different subgraphs.
The nodes within each fabric may be interconnected based on the local topology of that fabric.
Link connections may be considered edges between the network elements. There may be multiple edges with the same or unique attributes between two nodes.
Attributes/features and weights may be associated with the connections between nodes. For example, edges may be associated with features/attributes related to a link, including but not limited to: link bandwidth, latency, cost metrics, quality of service (QOS), reliability, SLA compliance, etc. In one or more embodiments, depending upon the desired design specifications, the features may also have associated weights to increase or decrease the importance of certain features.
Feature extraction may be performed on nodes, edges, or both by performing feature engineering methods, such as classification methods (e.g., degree centrality, betweenness centrality, closeness/harmonic centrality, eigen vector, weekly/strongly connected components, label propagation, etc.) and edge feature (e.g., number of links, link bandwidth, latency, edge source, edge destination (e.g., single node, another fabric, etc.), media type (e.g., fiber, copper, etc.). It shall be noted that any identifier, feature, attribute, quality, metric, etc. may be used as feature or weight.

A graph representation allows for visualizing and analyzing of network elements and relationships between different elements-which may be comprise different levels of a multi-fabric network topology including individual network devices, a part of a network, an entire network fabric, part of a multi-fabric network, and an entire multi-fabric network.

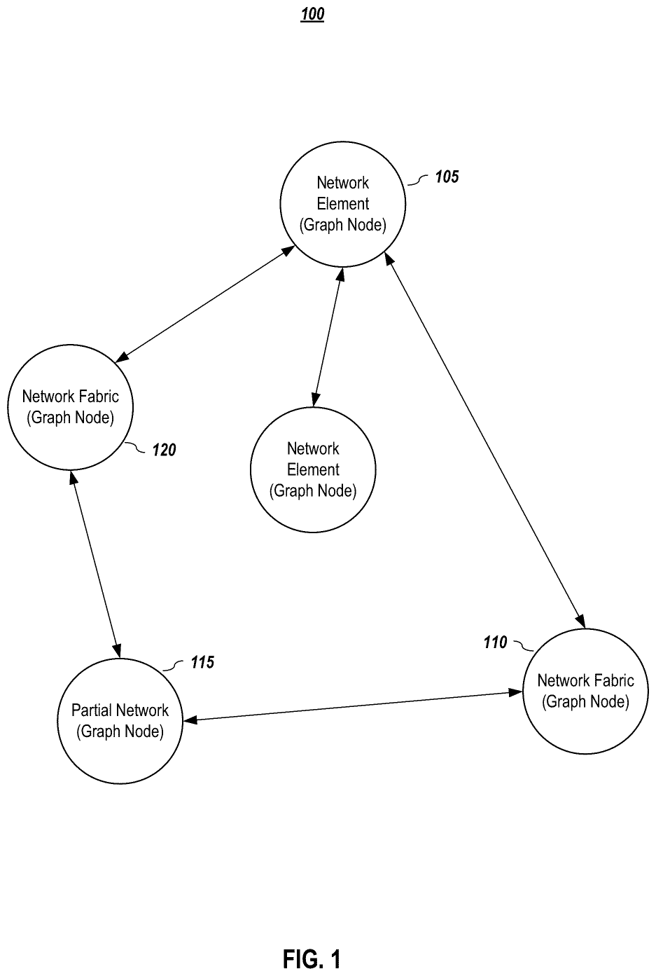

FIG. 1 depicts a multi-fabric network modeled as an undirected acyclic graph 100, according to embodiments of the present disclosure. Note the depicted example includes nodes that may represent a single network element (e.g., node 105), which may be a single network information handling system, while nodes 120 and 110 represent entire network fabrics, and finally, node 115 represents part of a network topology. In one or more embodiments, the weighted undirected acyclic graph may have levels/groups and the graph structure may change depending upon the level at which it is being viewed. For example, the graph 100 in FIG. 1 may be a top-level view, but zooming into a node (e.g., node 120) may reveal a nested graph representing the network elements and their links within that fabric 120. Thus, in one or more embodiments, the graph may be in a self-similar or fractal-like representation.

As noted above, in one or more embodiments, the graph incorporates not only the components (individually and as groups or levels) of the multi-fabric network but also relationships and features—e.g., the connectivity patterns within each fabric, how data flows between different parts of the network, link features, properties of a network or fabric, etc. Using a graph representation not only provides a means for representing networks that can be input into a multi-fabric design generator system, but in one or more embodiments, it outputs a graph representation that presents the final output graph for a multi-fabric design.

In one or more embodiments, a feature set may be generated for the nodes and edges of the graph. For each node and edge in the multigraph, features may be extracted to create a corresponding feature vector or matrix. The same number of features may be used for all nodes or for all edges, but it shall be noted that different numbers and different types of features may be used for different nodes or different edges. For example, nodes or edges of a certain type or class may have the same set of features but that set of features may be different for nodes or edges of a different type or class. In one or more embodiments, if a feature is not relevant to a node or edge, its value be set to indicate such. For example, a cost metric for a compute node or a transport node may be set to 0 (zero) if the user owns (or will own) the node and only pays for links. In one or more embodiments, one or more of the features may be the level at which a network element exists within a nested graph.

Features, whether for a node or for an edge, may comprise a number of elements. For an information handling system, features may include its specifications and supported features, such as device model, central processor unit (CPU) type, network processor unit (NPU) type, number of CPU cores, Random Access Memory (RAM) size, number of 100 G, 50 G, 25 G, 10 G ports, rack unit size, operation system version, cost, average energy consumption, supply chain availability, end-of-life date for product, etc. For network nodes that represent a fabric, the features may comprise provider, link bandwidth, one-time cost, latency, one or more cost metrics (e.g., cost/time unit), quality of service (QOS), reliability, SLA compliance, features, ratings, etc. For example, Amazon Web Services (AWS) or Microsoft Azure may provide transport functionality (e.g., AWS Cloud WAN (wide area network) or Azure Virtual WAN), which may be modeled as core transport nodes.

Additional examples of features may include: node type (e.g., vendor fabric (multiple), Megaport, Zayo, AWS CloudWAN, Equinix, etc.), link speed (e.g., 100M, 1 G, 10 G, etc.), link latency, operational status/state of links & elements, one or more cost metrics (e.g., cost per link to operate, cost per node to operate, etc.), per link or per node SLA compliance (e.g., percentage of time when SLA was achieved), link or node reliability (e.g., obtained from long-term telemetry), redundancy (e.g., number of paths between end-points), link or node security rating, information technology (IT) quality factor (e.g., IT quality factor per node)—API (application programming interface) automation, performance, troubleshooting, etc., green energy ratings, data transfer costs (e.g., ingress/egress costs), data sovereignty (e.g., links or nodes cannot be in certain geographical locations), etc. In one or more embodiments, nodes and edges may be labeled with a tuple (which may be a vector or a matrix) that comprises the associated values for the features. A simple example of a tuple may be: (cost/time unit, one-time cost, latency, throughput, reliability), although other metrics and formats may be used. It shall be noted that any attribute or relationship related to a node or an edge may be used as a feature. Categorical (e.g., nominal, ordinal) features may be converted into numeric features using label encoders, one-hot vector encoding, or other encoding methodologies.

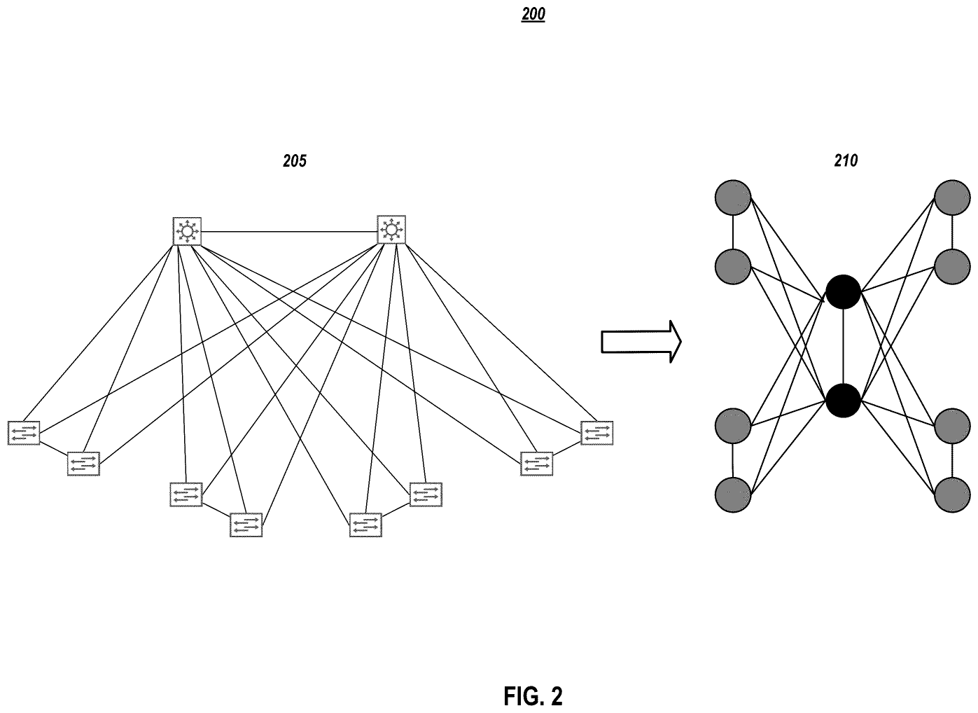

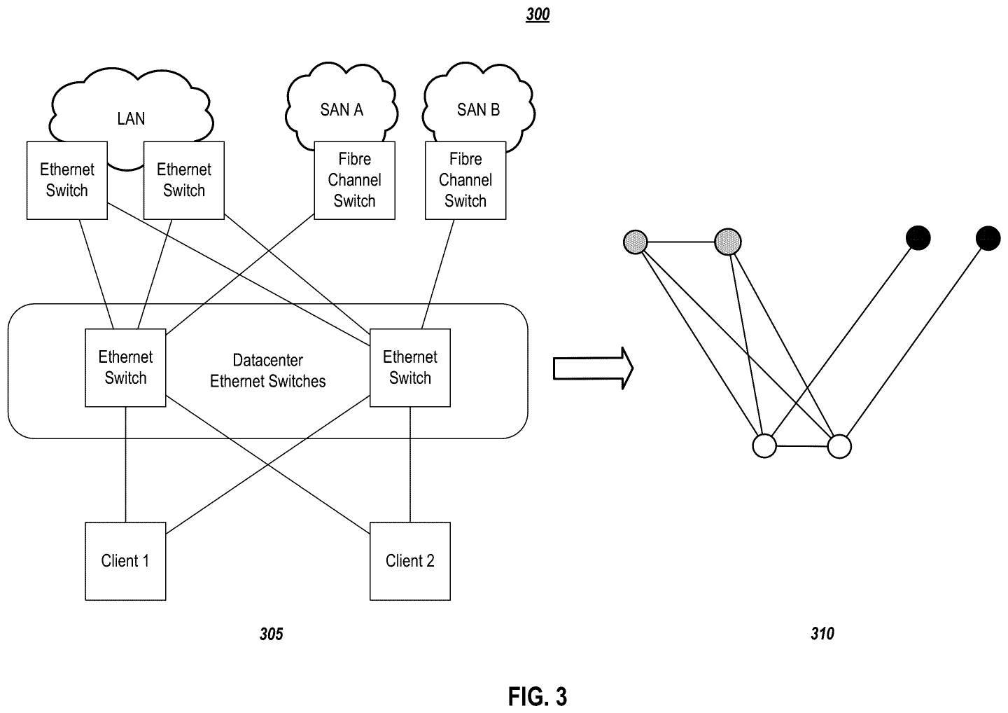

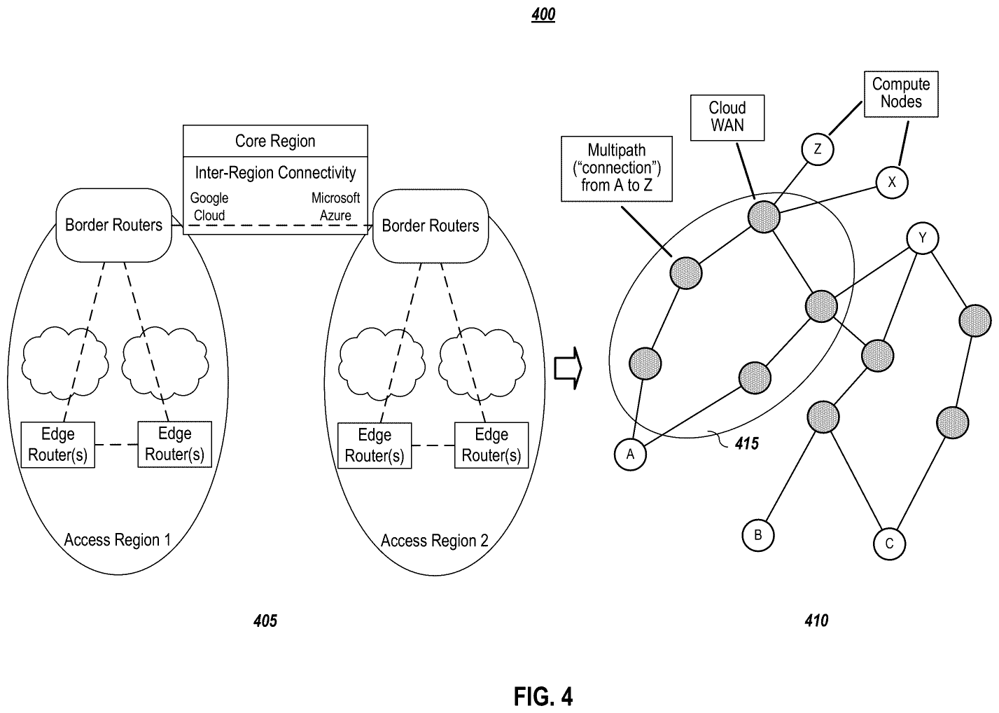

FIG. 2, FIG. 3, and FIG. 4 depict examples of network topologies represented as undirected acyclic graphs, according to embodiments of the present disclosure. In FIG. 2, the wiring diagram of a leaf-spine topology 205 is converted into a graph 210. Similarly, the CLOS fabric topology 305 of FIG. 3 is represented as a graph 310. FIG. 4 depicts a graphical multi-fabric topology 405, which may be represented as a graph 410. Note that the features, such as the role of a network element (e.g., core router, edge/border router, etc.) may be captured as a feature. For example, all the nodes that are shaded are core fabric network elements, while nodes with letters are edge network elements. Note also that a feature of a network fabric (e.g., identified as part of Access Region 1, which is represented by grouping 415) may be included as a feature for each of the corresponding network elements or may be represented as a single node 415 at a high-level graph depiction.

Note that these examples are provided only by way of illustrating the concept of converting a network topology to a weighted undirected acyclic graph. Most real-world networks contain vastly more devices; for example, one might assume an order of magnitude of a multi-fabric of 100's of nodes (fabrics). Note also that the number of nodes within a fabric can vary dramatically. For example, the number of nodes for core fabrics is likely to be much higher than for edges.

### 2. Training System and Method Embodiments

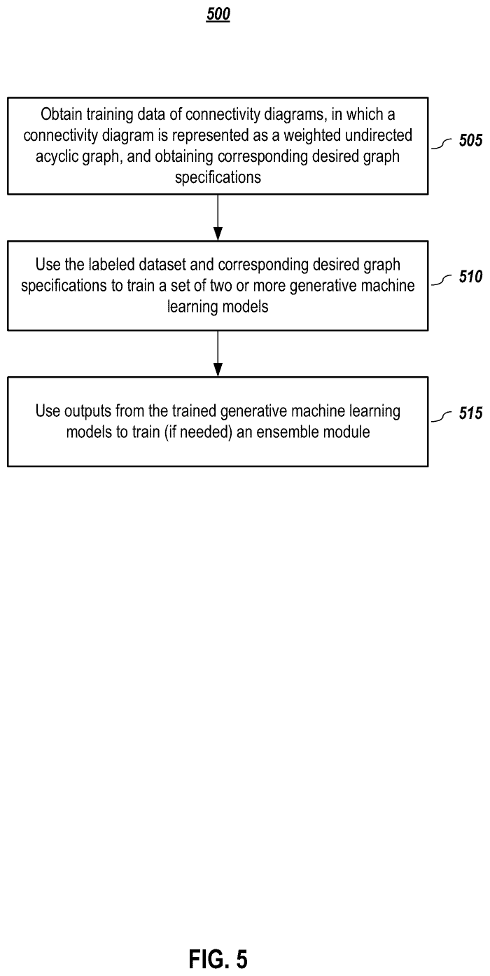

Turning now to FIG. 5, depicted is an overview methodology for training a multi-fabric design system, according to embodiments of the present disclosure. In one or more embodiments, a preliminary step comprises obtaining (505) training data of connectivity diagrams. The connectivity diagram may be represented as a weighted undirected acyclic graph, as discussed in the prior section.

The training data may be obtained by converting a number of different network elements and network topologies to connectivity graphs (e.g., weighted undirected acyclic graphs). The connectivity graphs may represent actual deployed networks or may be synthetic (i.e., not actually deployed networks) networks. Connectivity graphs may be synthesized by permuting existing or known networks. In one or more embodiments, a value or set of values may be associated with the connectivity graph to create labelled data for training. The value(s) may represent a quality factor related to part(s) or all of the network represented by the connectivity graph. One benefit of generating a dataset comprising deployed networks is that they provide actual metrics related to the networks' functioning, costs, quality, etc. In one or more embodiments, the labeled dataset may comprise different network levels (e.g., a network element, part of a fabric, a whole fabric, and a multi-fabric).

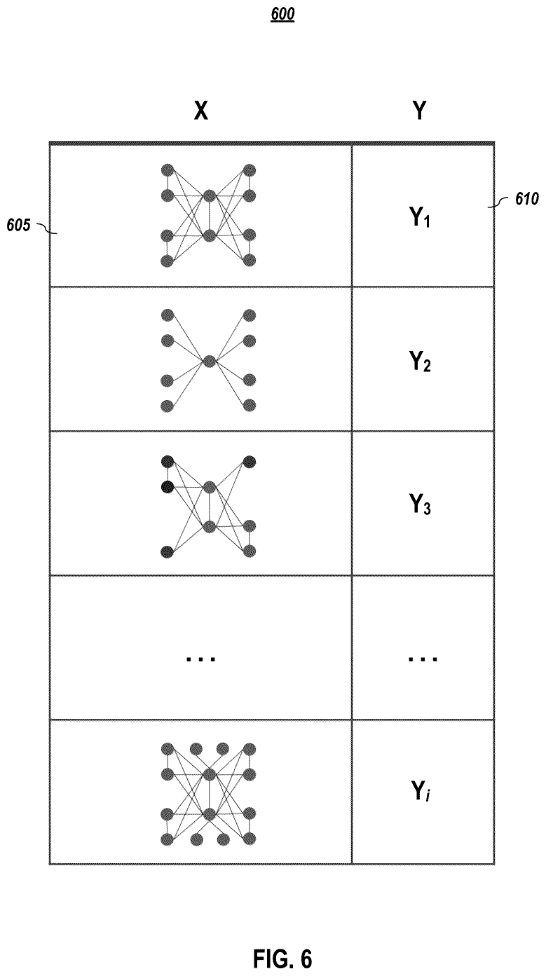

FIG. 6 graphically depicts a training dataset in which a feature matrix, X, for each connectivity diagram (graphically illustrated in FIG. 6, see, e.g., 605) has a corresponding score (e.g., Y₁ 610), according to embodiments of the present disclosure. As noted above, the score may be a single value (e.g., representing overall validity/quality or overall score based upon one or more design criteria and/or design constraints) or a set of values giving a score to parts of the connectivity graph (e.g., individualized validity/quality scores based upon relevant design criteria and/or design constraints for that portion of the graph). For the training data, every data entry in the dataset may be considered as a tuple (X, Y), wherein:
Xᵢ: a representation of an input connectivity multigraph; and
Yᵢ: Score

These scores may be used as corresponding ground-truth scores for training a multi-fabric design generator system embodiment. In one or more embodiments, the overall dataset may have a distribution of numbers of good and not-so-good connection meshes. Note that the dataset may be updated with new deployments thereby providing additional data to further fine-tune a trained multi-fabric design generator system.

In one or more embodiments, the dataset may be divided into 80-10-10 distribution representing training, cross-validation, and testing, respectively.

Returning to FIG. 5, the labeled data may be used to train (510) a set of two or more generative machine learning models of a multi-fabric design generator. Given a set of trained generative machine learning models, the outputs of the generative machine learning models may be used to train one or more ensemble methodologies to obtain (515) a final output graph. As discussed below, depending upon the embodiment, training of an ensemble method may not be needed (e.g., if it is rule-based or based upon heuristics).

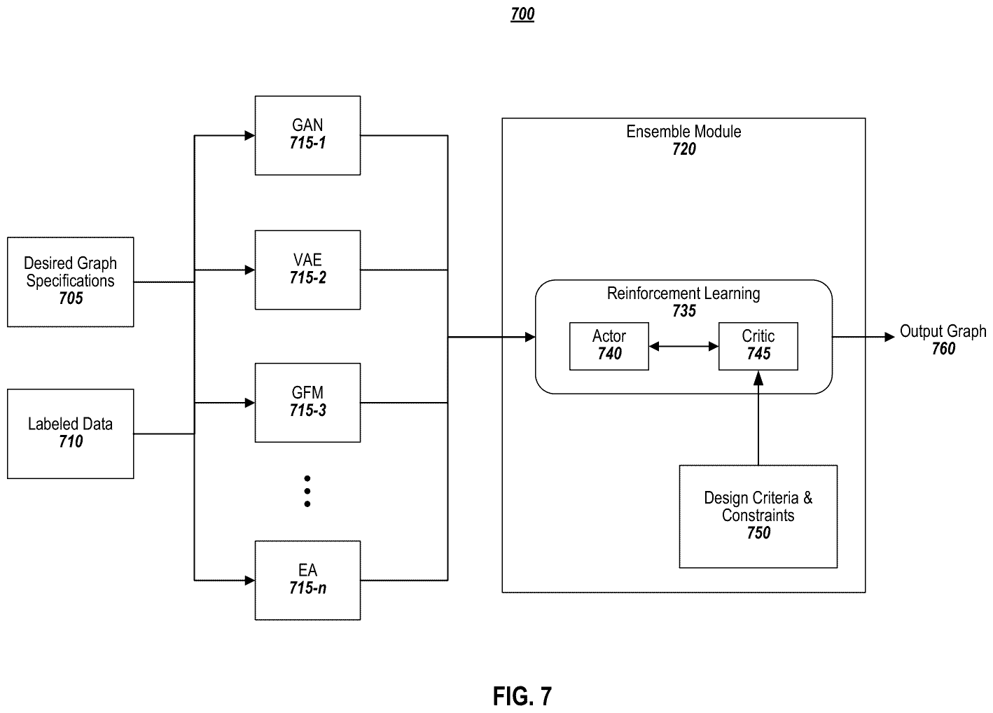

FIG. 7 graphically depicts a multi-fabric design system architecture during training, according to embodiments of the present disclosure. As depicted in FIG. 7, the multi-fabric design generator system architecture 700 may receive the labeled data 710 as an input. As explained earlier, the labeled dataset may be obtained using organic and synthetic graph topologies. In addition to the labeled data 710, the depicted system 700 may also receive corresponding desired graph specifications (or templates), which may be used to set forth requirements for the final output graph 760. That is, in one or more embodiments, an entry in the labeled data 710 has a corresponding graph specification/template 705.

As illustrated, the plurality of generative machine learning models 715 of the multi-fabric design generator system receive a desired graph specification 705 as an input and use it to generate a new undirected acyclic graph (or connectivity graph) of a multi-fabric design based on patterns and structures the generative model has learned from the labeled data. As opposed to discriminative models that are used to classify the input data, these generative models create new topologies based on the desired graph specification.

Examples of generative machine learning models that may be employed by the multi-fabric design generator system may include (but are not limited to):
Generative Adversarial Network (GAN): A GAN model architecture typically involves two sub-models, a generator model for generating new examples and a discriminator model for classifying whether generated examples are real, from the domain, or fake, generated by the generator model.
Variational Autoencoders (VAEs): VAEs are another type of generative model that may be used to generate new data or architectures. VAEs typically comprise an encoder and a decoder, but they use a probabilistic approach to learn the underlying distribution of the data. VAEs may be used to generate new data by sampling from the learned distribution, and they may also be used for unsupervised representation learning.
Generative Flow Models: Generative Flow Models are a class of generative models that use a series of invertible transformations to map a simple distribution (such as a Gaussian distribution) to a target distribution of the data. This approach allows for efficient sampling from the target distribution and may be used to generate new data or architectures.
Auto-Regressive Models: Auto-Regressive Models are another class of generative models that model a conditional probability of each data point given previous data points. These models may be used to generate new data or architectures by sampling from the learned probability distribution.
Evolutionary Algorithms (EA): Evolutionary Algorithms are a family of optimization methods inspired by natural evolution. They may be used to optimize the design of an architecture by generating and evolving a population of candidate architectures based on their fitness.

As depicted in the system 700 of FIG. 7, these models may be employed in parallel to generate the multi-fabric design topologies. It shall be noted that other machine learning models and systems may be employed. It shall also be noted that while embodiments herein discuss a supervised training methodology, one or more of the generative models may not be a supervised model (e.g., semi-supervised or unsupervised) and may be trained accordingly.

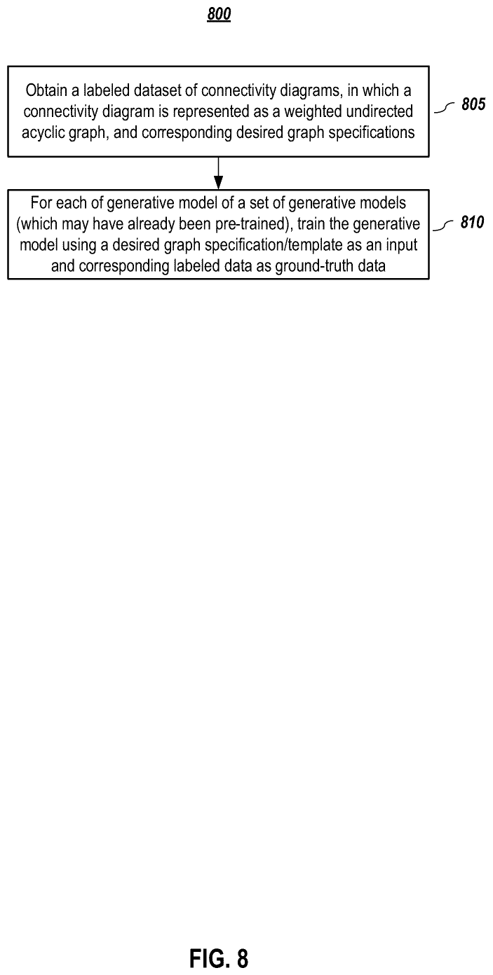

FIG. 8 depicts a methodology for training a set of generative models, according to embodiments of the present disclosure. In one or more embodiments, desired graph specifications and corresponding labeled data of connectivity diagrams are obtained (805). The desired graph specifications (or simply “graph specifications”) are used as inputs into one or more generative models, and the corresponding labeled data is used as ground-truth data for supervised learning of the generative models. In one or more embodiments, a desired graph specification may correspond to or be applicable to more than one connectivity diagram entry in the labeled data of connectivity diagrams. Also, recall that the training data 710 may comprise entries for connectivity graphs at different levels (e.g., a network device, part of a fabric, a single fabric, and a multi-fabric), in which a connectivity diagram is represented as a weighted undirected acyclic graph.

For each of the generative model of a set of generative models (which may have already been pre-trained on this data and/or other data), the generative model is trained (810) using a desired graph specification/template as an input and its corresponding labeled data as ground-truth data.

As noted above, given a set of trained generative models, any one of the outputs of the generative model may be used as a final output graph of a multi-fabric design. However, the system 700 of FIG. 7 uses two or more of the outputs from the generative models 715 as inputs into an ensemble module 720 to generate a final output graph.

In one or more embodiments, an ensemble module may use one or more ensemble methods to obtain a final output graph. For example, given a set of trained generative models, any one of the outputs of the generative model may be selected as a final output graph of a multi-fabric design. An output may be selected at random or may be selected based upon one or more metrics (e.g., selecting the output that has a highest probability measure from the generative model for how well it meets the graph specification, design constraints, and/or design criteria). Note that such rules-based approaches may not require iterative training.

However, in one or more embodiments, two or more of these outputs may be treated as preliminary outputs, and an ensemble methodology may be trained to generate (515) a better final output graph by selecting or combining portions from different outputs. By combining the output of multiple generative models using an ensemble approach, the overall quality of the final generated architecture is improved by leveraging the strengths of different models, and it may also reduce the risk of mode collapse or other limitations of individual models.

Returning to FIG. 7, the depicted ensemble module 720 may comprise a Reinforcement Learning (RL) component 735 that combines the outputs of the multiple generative models. An RL module 735 may employ a variant of actor-critic method 740, 745, in which the actor learns to select portions from the preliminary outputs of the generative models and the critic evaluates the performance of the ensemble. In one or more embodiments, the RL module 735 may be conditioned using design criteria and design constraints 750. In one or more embodiments, the design criteria and design constraints may be the same as the desired graph specification, although they may be different.

In one or more embodiments, the design criteria may comprise a set of specifications/features for the desired final output network. For example, the design criteria may include (but are not limited to) such features as: throughput (e.g., lowest throughput of all components in a path), which may be specified per path; latency (e.g., sum of latencies of all components along a path), which may be specified per path; resiliency (e.g., a maximum threshold per path/connection failure probability (e.g., edge node to AWS)); path (e.g., Node A to Node Z, can go through Nodes B, C, . . . (e.g., “Datacenter Edge X” to AWS)) (note that a path may traverse multiple links and nodes); connection (e.g., Nodes A and B may be connected by multiple paths (a “connection” may be a set of paths between two nodes—multiple paths in a connection may be used for redundancy reasons and for load sharing), etc. In one or more embodiments, the design criteria may include any of the features as discussed herein.

Related to, or as part of the design criteria, there may also be design constraints. In one or more embodiments, the design constraints may comprise a set of conditions/features that set conditions or limits for the desired final output network. For example, the design constraints may include (but are not limited to) such conditions as: minimal overall financial cost (e.g., this may comprise inter-fabric links, fabrics, recurring costs, one-time costs, time aspect (e.g., pricing may vary with the time of day for recurring costs), etc.); service level agreement (SLA) constraints; regulatory constraints; etc. A goal may be to design a network having a minimal financial cost (e.g., minimize Capital Expenditure (CapEx) and Operational Expenses (OpEx)), with the desired set of characteristics for a set of paths (e.g., latency, throughput, reliability). In one or more embodiments, the design constraints may include any of the features as discussed herein.

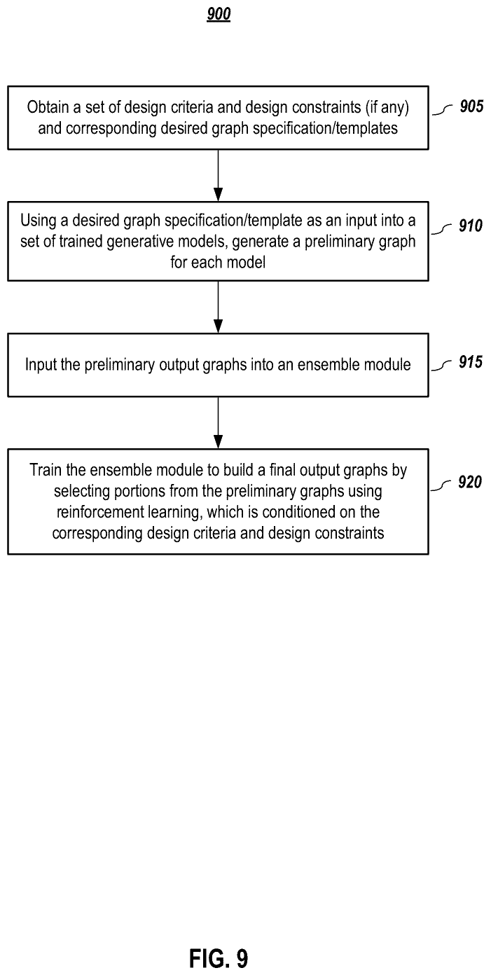

FIG. 9 depicts a methodology for training an ensemble module of a multi-fabric design generator, according to embodiments of the present disclosure. In one or more embodiments, the methodology may commence by obtaining (905) a set of design criteria and design constraints (if any) and corresponding desired graph specification/templates. The desired graph specification/template is used (910) as an input into the trained generative machine learning models to generate a preliminary graph from each model for each graph specification. These preliminary graphs are input (915) into an ensemble module. In one or more embodiments, the ensemble module is trained (920) to build a final output graph corresponding to the design graph specification by selecting portions from the preliminary graphs for that design graph specification using reinforcement learning. In one or more embodiments, the RL module may be conditioned on the corresponding design criteria and design constraints for that design graph specification.

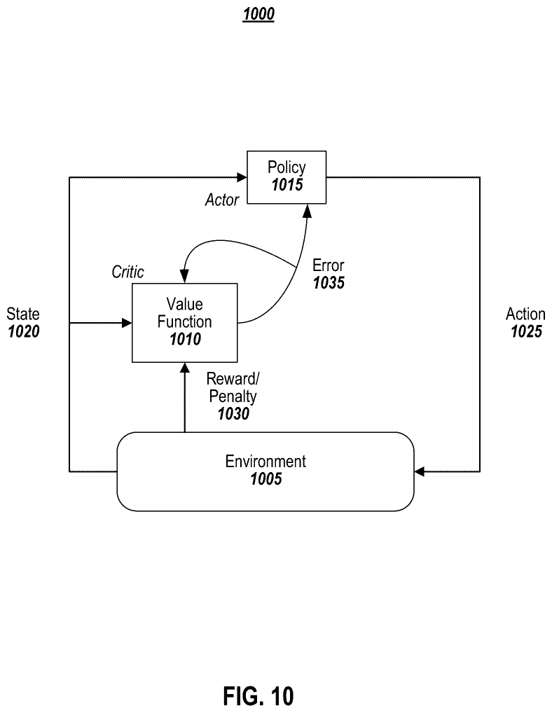

FIG. 10 graphically depicts an implementation of reinforcement learning, according to embodiments of the present disclosure. At a high-level, reinforcement learning (RL) is a type of machine learning where an agent or actor learns to make decisions by interacting with an environment 1005. The agent receives feedback in the form of rewards or penalties based on its actions 1025, and its objective is to maximize the cumulative reward over time. Through trial and error, the agent learns which actions 1025 lead to favorable outcomes and adjusts its behavior accordingly to maximize the cumulative reward signal.

The actor is the entity making decisions, and the environment is what the agent interacts with. At each step of interaction, the actor receives a representation of the environment's state 1020, capturing relevant information. Based on the state, the actor selects an action 1025 from a set of possible actions. These actions influence the state 1020 of the environment. After taking an action, the actor receives feedback from the environment in the form of a reward signal 1030, indicating the immediate benefit or detriment of the action. As noted above, the goal is to maximize the cumulative reward over time. The actor's decision-making strategy may be governed by a policy 1015, which maps states to actions. The policy may be deterministic or stochastic.

Through repeated interactions with the environment, the actor learns the optimal policy by exploring different actions and observing their outcomes. This learning process involves updating the actor's understanding of the environment based on the received rewards. There is a trade-off between exploration (i.e., trying new actions to discover their effects) and exploitation (i.e., choosing actions that are known to yield high rewards). RL approaches tend to balance exploration and exploitation to efficiently learn the optimal policy.

RL methods often use value functions to estimate the expected cumulative reward of taking an action in a particular state. These functions guide the actor's decision-making by quantifying the long-term desirability of actions. In one or more embodiments, the desired criteria and the desired constraints may correspond to the value function, the policy, or a combination thereof.

In one or more embodiments, the RL module may additionally or separately use weighting to build a final graph output. As a component of the ensemble learning process, an RL module learns weights assigned to parts of each model's preliminary graph in the ensemble. In this approach, the weights assigned to parts of each model's preliminary graph may be treated as the actions of an RL agent, and the validation performance of the ensemble using validation data as a reward signal. The RL agent may then learn a policy that maximizes the expected reward by adjusting the weights.

One approach to implementing such an embodiment is to use a variant of the actor-critic RL methodology, where the actor learns to choose weights for parts of each model's preliminary graph and the critic evaluates the performance of the ensemble. The actor may be implemented as a neural network that takes the outputs of each model as inputs and produces a set of weights for each model as output. The critic may be implemented as a separate neural network that takes the ensemble output as input and produces a reward signal as output, which may be a scalar value.

During training, in one or more embodiments, the actor is updated using a policy gradient method, while the critic may be updated using a temporal difference (TD) learning method. The updates to the actor and critic may be based on the difference between the predicted ensemble output and the actual ensemble output, which is used as the reward signal.

In one or more embodiments, the RL may include one or more methodologies for handling structural differences in the preliminary output graphs generated by the trained generative machine learning modules when creating an ensemble model. Presented below are some embodiments that may be used to address structural differences in the preliminary output graphs (e.g., number of nodes, edges, overall topology, etc.).
Template definition: The desired final graph to be generated by the multi-fabric design generator system is not arbitrary since it represents various physical entities (e.g., routing/switching elements, links, connections, routing sub-network, etc.) as logical identifiers (nodes, edges, sub-graphs, etc.). The desired graph specification identifies or promotes a common structure or template because it is fed into each of the generative machine learning models. In one or more embodiments, the desired graph specification may be used to fixed attributes, such as having a set number of nodes and edges or having a general graph structure that is desired to be achieved.
Node and Edge Alignment: In one or more embodiments, for each preliminary output graph from the individual generative machine learning models, the nodes and edges may undergo an alignment to identify and align the common structure. Many image alignment methods and other such alignment methods may be used or adapted to align the preliminary output graphs. Note that since these are multi-fabric designs, there will be clear edges that dramatically aid alignment. The result will comprise mappings of a common structure of nodes and edges across the generative machine learning models' preliminary output graphs for a corresponding input graph specification.

Examples of node and edge mapping methods that may be employed may include, but are not limited to the following methods:
Node Features and Matching: In one or more embodiments, nodes may be embedded based on their features/attributes. The embeddings may be generated using techniques like node2vec or GraphSAGE. Using the embeddings allows for easier comparison. Then, a matching method may be employed to pair nodes between different graphs. Matching may involve calculating node similarities based on embeddings and/or graph features and may use a graph edit distance and/or employ heuristics.
Edge Features and Matching: Since the graphs in embodiments herein have edge features/attributes, these features may be considered during alignment. In one or more embodiments, edges may be matched in a similar matter as nodes (e.g., edge embeddings may be used with similarity measures to apply a similar matching approach to edges). In one or more embodiments, taking into account both source and target nodes along with edge attributes may be used to facilitate alignment and resolve ambiguities.
Handling Missing or Extra Elements: Some generative machine learning models may generate preliminary output graphs with extra nodes or edges, while others may have fewer elements. To address these discrepancies, rules and strategies may be defined to handle these differences. For example, nodes and edges that are common across preliminary outputs may be prioritized, and a secondary mechanism (e.g., another generative model) may be employed when adding or removing elements. The attributes/features associated with nodes and edges may also be considered. If a generative machine learning model generates additional information for nodes or edges, this information may be merged or prioritized during the reconciliation process. Furthermore, in one or more embodiments, a historical data may be maintained. That is, if certain generative machine learning models are consistently better in generating specific graph structures, they may be selected as a default or used if there is ambiguity between outputs. In one or more embodiments, weighted averaging may be used by assigning weights to the outputs of each of the generative machine learning models based on their performance in generating certain structural elements. In one or more embodiments, a voting mechanism may be used to address inconsistencies, in which the majority (weighted or unweighted) tally across the generative machine learning models decides whether to include or remove portions.

For example, in one or more embodiments, give N generative models, each of which produces a probability distribution over the space of possible generated data or architectures. The probability distribution output by the i^{th} model may be denoted as pᵢ(x), where x is a data point or architecture. The output of the N models may be combined using the following formula:

$$P ( x ) = \frac{1}{N} * {\sum }_{i = 1}^{N} ( {w}_{i} * {p}_{i} ( x ) )$$

where P(x) is the final probability distribution over the space of possible generated data or architectures, wᵢ is the weight assigned to the i^{th} model, and the sum is taken over all N models.

The weights wᵢ may be determined by the performance of each model on a validation set or through cross-validation. In one or more embodiments, higher weights may be assigned to models that perform better on the validation set, while lower weights are assigned to models that perform worse. The weights may also be learned using optimization techniques, such as gradient descent or other search methods.
Graph Rewriting: To modify the structure of the ensemble graph based on the aligned outputs, a graph rewriting mechanism may be employed. Employing a graph rewriting mechanism helps ensure that the final output graph follows the desired structure while incorporating diverse contributions. The following characteristics may be considered during graph rewriting:
Topology Alignment: Topology alignment in the graph rewriting step may involve adjusting the structure of aligned graphs to ensure coherence and consistency. The topology may be modified based on the aligned nodes and edges-aiming to create a final graph that adheres to certain structural constraints or desired characteristics.
Graph Edit Operations: Graph edit operations (such as insertions, deletions, substitutions, etc.) may be used to modify the structure. Differences observed during alignment may be used as a basis for these operations.
Topology Constraints: Constraints may be used to maintain the overall topology. For instance, a certain degree distribution may be enforced. Or, in one or more embodiments, the number of added and/or removed nodes may be limited.
Node/Edge attribute differences: Probabilistic matching may be used in which nodes and/or edges are matched with certain probabilities. Probabilistic approaches have the benefit of accounting for uncertainty in the alignment process.
Evaluation and Fine-Tuning: In one or more embodiments, to achieve coherent structures from the ensemble module, metrics may be defined to evaluate the quality of the alignment. These metrics may include structural similarity indices, precision-recall measures, and/or domain-specific criteria. Based on the evaluation results, the parameters of the alignment methods may be iteratively fine-tuned to improve outcomes. For example, similarity thresholds, embedding dimensions, matching constraints, and other factors may be adjusted.

By combining the output of multiple generative models using an ensemble approach, the overall quality of the final output graph is increased by leveraging the strengths of each individual model and reducing the risk of mode collapse or other limitations of individual models.

### C. Deployment Embodiments

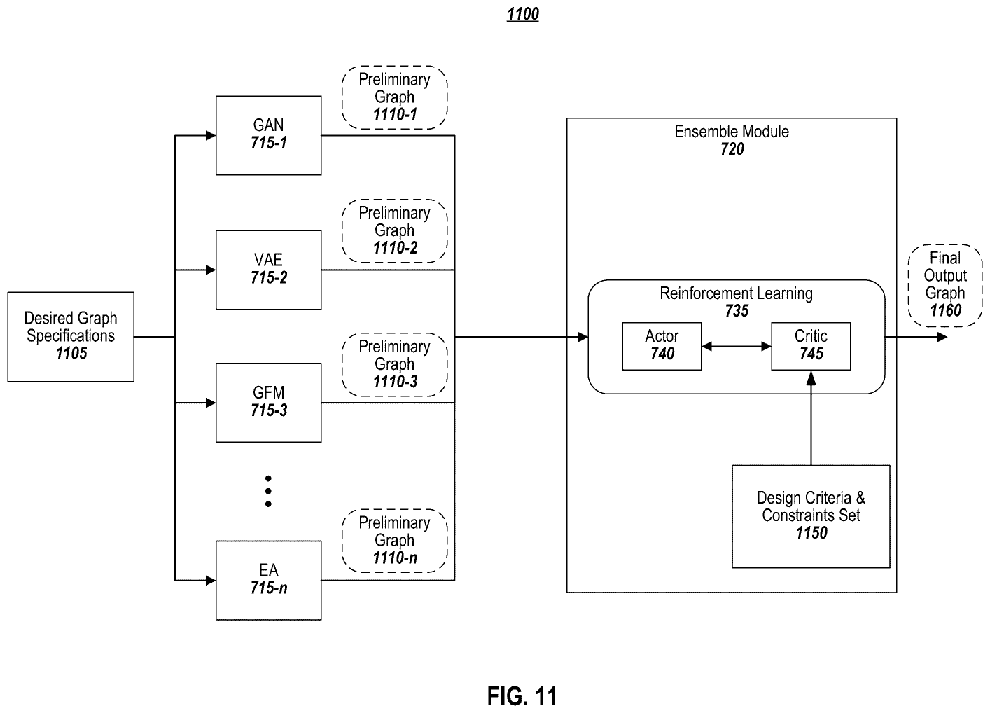

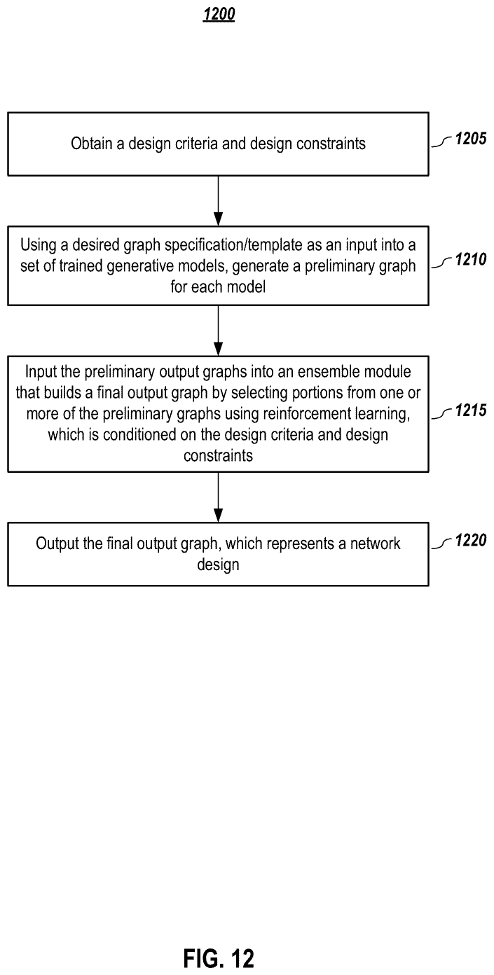

Turning now to FIG. 11, graphically depicted is a trained multi-fabric design system architecture for use during a deployment phase, according to embodiments of the present disclosure. FIG. 12 depicts an overview methodology for using a trained multi-fabric design system, according to embodiments of the present disclosure. In one or more embodiments, a design criteria and design constraints set 1150 is obtained (1205), which may be specified or supplied by a user or network architecture designer. A graph specification/template 1105, which may also be user specified (and may be the same as or similar to the design criteria and design constraints set 1150) is input into a set of trained generative machine learning models to generate (1210) a preliminary output graph 1110 for each model corresponding to that graph specification/template 1105.

The preliminary output graphs 1110 are input (1215) into a trained ensemble module 720 that builds a final output graph 1160 by selecting portions from one or more of the preliminary graphs 1110 using reinforcement learning, which may be conditioned on the design criteria and design constraints.

The final output graph 1160 is the final generated graph by the model and represents a multi-fabric design. In one or more embodiments, the output format may be a JSON-formatted wiring diagram of network elements and their connectivity information to the other elements-although other formats may be used.

### D. System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drives, solid state drive, or both), one or more network ports for communicating with external devices as well as various input and output (I/O) devices. The computing system may also include one or more buses operable to transmit communications between the various hardware components.

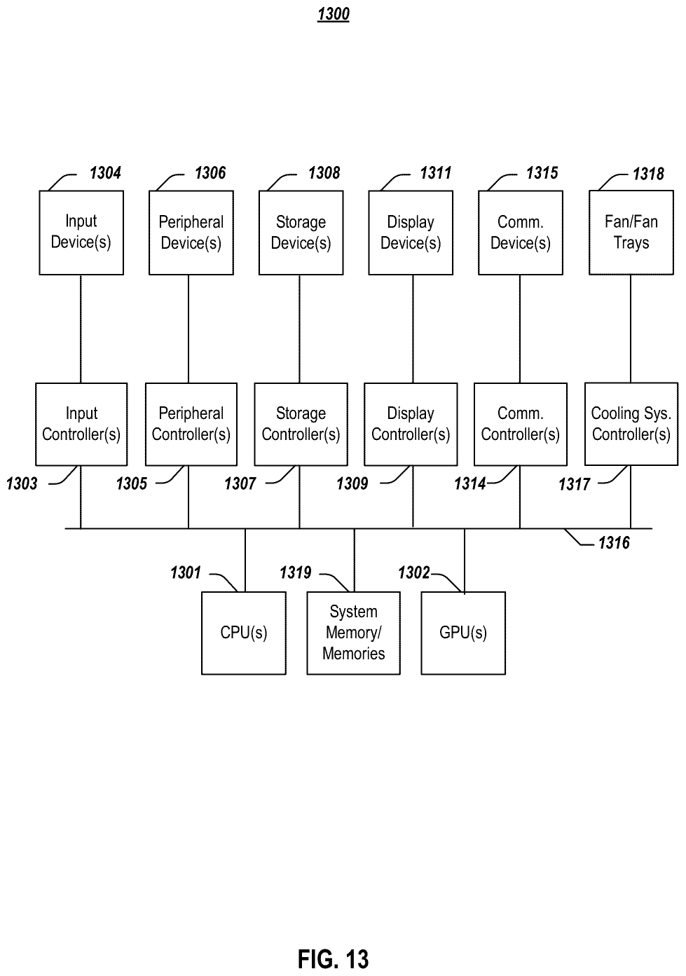

FIG. 13 depicts a simplified block diagram of an information handling system (or computing system), according to embodiments of the present disclosure. It will be understood that the functionalities shown for system 1300 may operate to support various embodiments of a computing system—although it shall be understood that a computing system may be differently configured and include different components, including having fewer or more components as depicted in FIG. 13.

As illustrated in FIG. 13, the computing system 1300 includes one or more CPUs 1301 that provides computing resources and controls the computer. CPU 1301 may be implemented with a microprocessor or the like and may also include one or more graphics processing units (GPU) 1302 and/or a floating-point coprocessor for mathematical computations. In one or more embodiments, one or more GPUs 1302 may be incorporated within the display controller 1309, such as part of a graphics card or cards. The system 1300 may also include a system memory 1319, which may comprise RAM, ROM, or both.

A number of controllers and peripheral devices may also be provided, as shown in FIG. 13. An input controller 1303 represents an interface to various input device(s) 1304, such as a keyboard, mouse, touchscreen, stylus, microphone, camera, trackpad, display, etc. The computing system 1300 may also include a storage controller 1307 for interfacing with one or more storage devices 1308 each of which includes a storage medium such as magnetic tape or disk, or an optical medium that might be used to record programs of instructions for operating systems, utilities, and applications, which may include embodiments of programs that implement various aspects of the present disclosure. Storage device(s) 1308 may also be used to store processed data or data to be processed in accordance with the disclosure. The system 1300 may also include a display controller 1309 for providing an interface to a display device 1311, which may be a cathode ray tube (CRT) display, a thin film transistor (TFT) display, organic light-emitting diode, electroluminescent panel, plasma panel, or any other type of display. The computing system 1300 may also include one or more peripheral controllers or interfaces 1305 for one or more peripherals 1306. Examples of peripherals may include one or more printers, scanners, input devices, output devices, sensors, and the like. A communications controller 1314 may interface with one or more communication devices 1315, which enables the system 1300 to connect to remote devices through any of a variety of networks including the Internet, a cloud resource (e.g., an Ethernet cloud, a Fibre Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1300 comprises one or more fans or fan trays 1318 and a cooling subsystem controller or controllers 1317 that monitors thermal temperature(s) of the system 1300 (or components thereof) and operates the fans/fan trays 1318 to help regulate the temperature.

In the illustrated system, all major system components may connect to a bus 1316, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

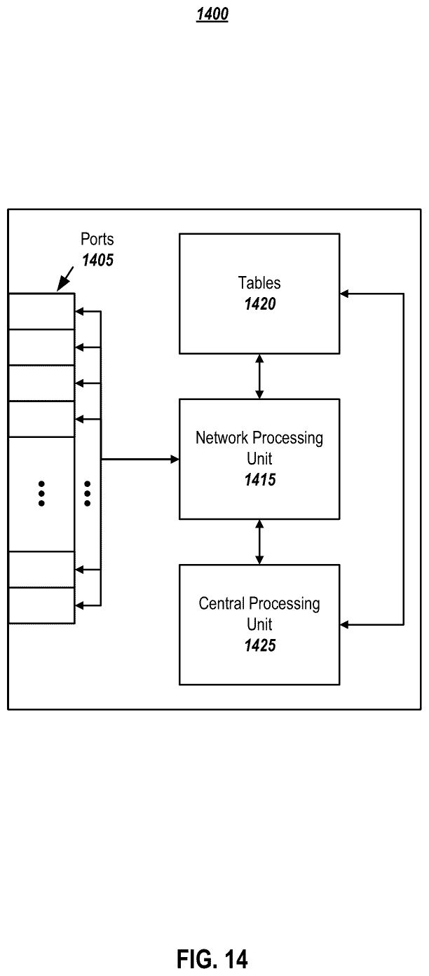

FIG. 14 depicts an alternative block diagram of an information handling system, according to embodiments of the present disclosure. It will be understood that the functionalities shown for system 1400 may operate to support various embodiments of the present disclosure-although it shall be understood that such system may be differently configured and include different components, additional components, or fewer components.

The information handling system 1400 may include a plurality of I/O ports 1405, a network processing unit (NPU) 1415, one or more tables 1420, and a CPU 1425. The system includes a power supply (not shown) and may also include other components, which are not shown for sake of simplicity.

In one or more embodiments, the I/O ports 1405 may be connected via one or more cables to one or more other network devices or clients. The network processing unit 1415 may use information included in the network data received at the node 1400, as well as information stored in the tables 1420, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media comprising one or more sequences of instructions, which, when executed by one or more processors or processing units, causes steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other non-volatile memory devices (such as 3D XPoint-based devices), ROM, and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A processor-implemented method comprising:
for each graph specification of a set of graph specifications, inputting the graph specification into each generative machine learning model of a plurality of generative machine learning models of a multi-fabric design generator system, in which the generative model uses the graph specification to generate a graph output representing a multi-fabric network design corresponding to the graph specification;
for at least some of the generative machine learning models of the multi-fabric design generator system, using labeled data of connectivity diagrams corresponding to the graph specifications as ground-truth data to train the generative models by comparing the graph outputs of the at least some of the generative machine learning models with corresponding labeled data of connectivity diagrams to obtained trained generative models;
responsive to a stop condition for training an ensemble module of the multi-fabric design generator system not being reached, for each graph specification of a set of graph specification:
generating a set of preliminary graph outputs from the trained generative machine learning models using the graph specification as an input into the trained generative machine learning models; and
inputting the preliminary graph outputs into an ensemble module of the multi-fabric design generator system to train a reinforcement learning module to select portions from the preliminary graph outputs to build a final graph corresponding to the graph specification; and
responsive to a stop condition for training an ensemble module of the multi-fabric design generator system being reached, outputting the trained multi-fabric design generator system.

2. The processor-implemented method of claim 1 wherein a graph specification comprises a corresponding design criteria and constraints set and the reinforcement learning module is conditioned on the design criteria and constraints set.

3. The processor-implemented method of claim 2 wherein the graph specification is the corresponding design criteria and constraints set.

4. The processor-implemented method of claim 1 wherein each graph specification comprises a set of one or more requirements for a multi-fabric network design.

5. The processor-implemented method of claim 1 wherein a connectivity diagram of the labeled data of connectivity diagrams comprises an undirected acyclic graph in which a node represents a network element, part of a network fabric, a network fabric, or part of a multi-fabric network and edges represent links between nodes.

6. The processor-implemented method of claim 1 further comprising:
inputting a new graph specification into the trained generative machine learning modules of the trained multi-fabric design generator system to obtain preliminary graphs;
generating a final output graph using the trained ensemble module of the trained multi-fabric design generator system; and
outputting the final output graph, in which the final output graph represents a multi-fabric design corresponding to the graph specification.

7. The processor-implemented method of claim 6 wherein the ensemble module performed steps comprising:
aligning the preliminary graphs from the trained generative machine learning modules of the trained multi-fabric design generator system; and
using weighting to combine portions from at least some of the preliminary graphs to form the final graph.

8. A system comprising:
one or more processors; and
a non-transitory computer-readable medium or media comprising one or more sets of instructions which, when executed by at least one processor, causes steps to be performed comprising:
for each graph specification of a set of graph specifications, inputting the graph specification into each generative machine learning model of a plurality of generative machine learning models of a multi-fabric design generator system, in which the generative model uses the graph specification to generate a graph output representing a multi-fabric network design corresponding to the graph specification;
for at least some of the generative machine learning models of the multi-fabric design generator system, using labeled data of connectivity diagrams corresponding to the graph specifications as ground-truth data to train the generative models by comparing the graph outputs of the at least some of the generative machine learning models with corresponding labeled data of connectivity diagrams to obtained trained generative models;
responsive to a stop condition for training an ensemble module of the multi-fabric design generator system not being reached, for each graph specification of a set of graph specification:
generating a set of preliminary graph outputs from the trained generative machine learning models using the graph specification as an input into the trained generative machine learning models; and
inputting the preliminary graph outputs into an ensemble module of the multi-fabric design generator system to train a reinforcement learning module to select portions from the preliminary graph outputs to build a final graph corresponding to the graph specification; and
responsive to a stop condition for training an ensemble module of the multi-fabric design generator system being reached, outputting the trained multi-fabric design generator system.

9. The system of claim 8 wherein a graph specification comprises a corresponding design criteria and constraints set and the reinforcement learning module is conditioned on the design criteria and constraints set.

10. The system of claim 9 wherein the graph specification is the corresponding design criteria and constraints set.

11. The system of claim 8 wherein each graph specification comprises a set of one or more requirements for a multi-fabric network design.

12. The system of claim 8 wherein a connectivity diagram of the labeled data of connectivity diagrams comprises an undirected acyclic graph in which a node represents a network element, part of a network fabric, a network fabric, or part of a multi-fabric network and edges represent links between nodes.

13. The system of claim 8 wherein the non-transitory computer-readable medium or media further comprises one or more sets of instructions which, when executed by at least one of the one or more processors, causes steps to be performed comprising:
inputting a new graph specification into the trained generative machine learning modules of the trained multi-fabric design generator system to obtain preliminary graphs;
generating a final output graph using the trained ensemble module of the trained multi-fabric design generator system; and
outputting the final output graph, in which the final output graph represents a multi-fabric design corresponding to the graph specification.

14. The system of claim 13 wherein the non-transitory computer-readable medium or media further comprises one or more sets of instructions which, when executed by at least one of the one or more processors, causes steps to be performed comprising:
aligning the preliminary graphs from the trained generative machine learning modules of the trained multi-fabric design generator system; and
using weighting to combine portions from at least some of the preliminary graphs to form the final graph.

15. A non-transitory computer-readable medium or media comprising one or more sequences of instructions which, when executed by at least one processor, causes steps to be performed comprising:
for each graph specification of a set of graph specifications, inputting the graph specification into each generative machine learning model of a plurality of generative machine learning models of a multi-fabric design generator system, in which the generative model uses the graph specification to generate a graph output representing a multi-fabric network design corresponding to the graph specification;
for at least some of the generative machine learning models of the multi-fabric design generator system, using labeled data of connectivity diagrams corresponding to the graph specifications as ground-truth data to train the generative models by comparing the graph outputs of the at least some of the generative machine learning models with corresponding labeled data of connectivity diagrams to obtained trained generative models;
responsive to a stop condition for training an ensemble module of the multi-fabric design generator system not being reached, for each graph specification of a set of graph specification:
generating a set of preliminary graph outputs from the trained generative machine learning models using the graph specification as an input into the trained generative machine learning models; and
inputting the preliminary graph outputs into an ensemble module of the multi-fabric design generator system to train a reinforcement learning module to select portions from the preliminary graph outputs to build a final graph corresponding to the graph specification; and
responsive to a stop condition for training an ensemble module of the multi-fabric design generator system being reached, outputting the trained multi-fabric design generator system.

16. The non-transitory computer-readable medium or media of claim 15 wherein a graph specification comprises a corresponding design criteria and constraints set and the reinforcement learning module is conditioned on the design criteria and constraints set.

17. The non-transitory computer-readable medium or media of claim 15 wherein each graph specification comprises a set of one or more requirements for a multi-fabric network design.

18. The non-transitory computer-readable medium or media of claim 15 wherein a connectivity diagram of the labeled data of connectivity diagrams comprises an undirected acyclic graph in which a node represents a network element, part of a network fabric, a network fabric, or part of a multi-fabric network and edges represent links between nodes.

19. The non-transitory computer-readable medium or media of claim 15 further comprises one or more sets of instructions which, when executed by at least one of the one or more processors, causes steps to be performed comprising:
inputting a new graph specification into the trained generative machine learning modules of the trained multi-fabric design generator system to obtain preliminary graphs;
generating a final output graph using the trained ensemble module of the trained multi-fabric design generator system; and
outputting the final output graph, in which the final output graph represents a multi-fabric design corresponding to the graph specification.

20. The non-transitory computer-readable medium or media of claim 19 further comprises one or more sets of instructions which, when executed by at least one of the one or more processors, causes steps to be performed comprising:
aligning the preliminary graphs from the trained generative machine learning modules of the trained multi-fabric design generator system; and
using weighting to combine portions from at least some of the preliminary graphs to form the final graph.
